(19) United States
(12) Patent Application Publication
(10) Pub. No.: US 2006/0153285 A1
(43) Pub. Date: Jul. 13, 2006

(54) Dynamic interleaver depth change for a general convolutional interleaver

(75) Inventor: Cory S. Modlin, Chevy Chase, MD (US)

Correspondence Address: TEXAS INSTRUMENTS INCORPORATED, P O BOX 655474, M/S 3999, DALLAS, TX, 75265, US

(73) Assignee: Texas Instruments Incorporaated

(21) Appl. No.: 11/329,521

(22) Filed: Jan. 11, 2006

Related U.S. Application Data
(60) Provisional application No. 60/643,690, filed on Jan. 12, 2005.

(51) Int. Cl. H04B 1/38

(52) U.S. Cl. 375/222

(57) ABSTRACT

A system and method for changing the data rate over an interleaved latency path. The method overcomes shortfalls of the ADSL2 seamless rate adaptation (SRA) and dynamic rate repartitioning (DRR).

### CROSS-REFERENCE TO RELATED APPLICATIONS

This application claims the benefit of U.S. Provisional Patent Application No. 60/643,690 filed Jan. 12, 2005.

### FIELD OF THE INVENTION

This invention relates in general to telecommunications and, more particularly, to a digital subscriber line (DSL) communications system.

### BACKGROUND OF THE INVENTION

A conventional voice-band modem can connect computer users end-to-end through the Public Switched Telephone Network (PSTN). However, the transmission throughput of a voice-band modem is limited to below about 40 Kbps due to the 3.5 KHz bandwidth enforced by bandpass filters and codes at the PSTN interface points. On the other hand the twisted-pair telephone subscriber loop of a computer user has a much wider usable bandwidth. Depending on the length of the subscriber loop, the bandwidth at a loss of 50 dB can be as wide as 1 MHz. Transmission systems based on the local subscriber loops are generally called Digital Subscriber Lines (DSL).

As consumer demand for interactive electronic access to entertainment (e.g. video-on-demand) and information (Internet) in digital format has increased, this demand has effectively exceeded the capabilities of conventional voice-band modems. In response, various delivery approaches have been proposed, such as optical fiber links to every home, direct satellite transmission, and wideband coaxial cable. However, these approaches are often too costly, and cheaper alternatives have emerged, such as the cable modem which uses existing coaxial cable connections to homes and various high bit rate digital subscriber line (DSL) modems which use the existing twisted-pair of copper wires connecting a home to the telephone company central office (CO).

Several digital subscriber lines (DSL) technologies have been developed for different applications. The original 2B1 Q Digital Subscriber Line technology has been used as the ISDN Basic Rate Access channel U-interface. The High-bit-rate digital subscriber lines (HDSL) technology has been used as the repeaterless T1 service.

An example of prior art use of DSL techniques is the Asymmetrical Digital Subscriber Line (ADSL) signaling for the telephone loop that has been defined by standards bodies as a communication system specification that provides a low-rate data stream from the residence to the CO (upstream), and a high-rate data stream from the CO to the residence (downstream). The ADSL standard provides for operation without affecting conventional voice telephone communications, eg. plain old telephone service (POTS). The ADSL upstream channel only provides simple control functions or low-rate data transfers. The high-rate downstream channel provides a much higher throughput. This asymmetrical information flow is desirable for applications such as video-on-demand (VOD).

ADSL modems are typically installed in pairs, with one of the modems installed in a home and the other in the telephone company's central office servicing that home. The pair of ADSL modems are connected to the opposite ends of the same twisted-pair and each modem can only communicate with the modem at the other end of the twisted-pair; the central office will have a direct connection from its ADSL modem to the service provided (e.g., movies, Internet, etc.). Because an ADSL modem operates at frequencies higher than the voice-band frequencies, an ADSL modem may operate simultaneously with a voice-band modem or a telephone conversation.

A typical ADSL-based system includes a server located at the CO capable of providing movies or other data-intensive content, and a set-top-box at the residence that can receive and reassemble the data as well as send control information back to the CO. Meaningful display or use of the downstream content typically requires a sustained data rate through the modem. Due to the sustained data rate requirements, ADSL systems are primarily designed to function under certain operating conditions and only at certain rates. If a subscriber line meets the quality requirements, the ADSL modem can function, otherwise new line equipment must be installed, or line quality must be improved.

In particular, the ANSI standard ADSL calls for transmission of up to 6 megabits-per-second (Mbps) to a home (downstream) over existing twisted-pair and also for receipt of up to 640 kilobits per second (Kbps) from the home (upstream).

An ADSL modem differs in several respects from the voice-band modems currently being used for digital communication over the telephone system. A voice-band modem in a home essentially converts digital bits to modulated tones in the voice-band (30 Hz to 3.3 KHz), and thus the signals can be transmitted as though they were just ordinary speech signals generated in a telephone set. The voice-band modem in the receiving home then recovers the digital bits from the received signal. The current ITU V-series voice-band modem standards (e.g. V.32 and V.34) call for transmission at bit rates of up to 33.6 Kbps; even these rates are far too slow for real-time video and too slow for Internet graphics. In contrast, an ADSL modem operates in a frequency range that is higher than the voice-band; this permits higher data rates. However, the twisted-pair subscriber line has distortion and losses which increase with frequency and line length; thus the ADSL standard data rate is determined by a maximum achievable rate for a length of subscriber lines, e.g. 9,000 feet (9 kft) for 26 gauge lines, or 12 kft for 24 gauge lines.

Voice-band modem data speeds are limited by at least the following factors: 1) the sampling rate of the line cards in the central office is only 8 KHz; 2) the low bit resolution of the A/D and DIA converters used on the line cards reduces dynamic range; and 3) the length of the subscriber line (twisted-pair) and any associated electrical impairments. Although an ADSL modem avoids the first two factors, it also suffers from subscriber line length limitations and electrical impairments. FIG. 4c illustrates how the capacity of a subscriber line decreases with increasing line length for the two existing wire sizes. A similar capacity decrease with length applies to any type of twisted-pair subscriber line modem.

The ADSL standard uses discrete multitone (DMT) with the DMT spectrum divided into 256 4-KHz carrier bands and a quadrature amplitude modulation (QAM) type of constellation is used to load a variable number of bits onto each carrier band independently of the other carrier bands. The number of bits per carrier is determined during a training period when a test signal is transmitted through the subscriber line to the receiving modem. Based on the measured signal-to-noise ratio of the received signal, the receiving modem determines the optimal bit allocation, placing more bits on the more robust carrier bands, and returns that information back to the transmitting modem.

The modulation of the coded bits is performed very efficiently by using a 512-point inverse fast Fourier transform to convert the frequency domain coded bits into a time domain signal which is put on the twisted-pair by a D/A converter using a sample rate of 2.048 MHz (4.times.512). The receiving modem samples the signal and recovers the coded bits with a fast Fourier transform.

Alternative DSL modem proposals use line codes other than DMT, such as QAM, PAM, and carrierless AM/PM (CAP). Indeed, ISDN uses a 2 bit-1 quaternary (2B1Q) four level symbol amplitude modulation of a carrier of 160 KHz or higher to provide more data channels.

Modems using CAP or DMT, or other line codes, essentially have three hardware sections: (i) an analog front end to convert the analog signals on the subscriber line into digital signals and convert digital signals for transmission on the subscriber line into analog signals, (ii) digital signal processing circuitry to convert the digital signals into an information bitstream and optionally provide error correction, echo cancellation, and line equalization, and (iii) a host interface between the information bitstream and its source/destination.

However, these DSL modems have problems including: 1) higher bit rates for video that cause them to be complicated and expensive; 2) their bit rates are optimized for a fixed distance, making them inefficient for short subscriber loops and unusable for long subscriber loops; and 3) either DMT or CAP operates better for given different conditions (e.g. noise, etc.) that may or may not be present in a particular subscriber loop to which the DSL modem is connected.

Two-way digital communication systems with high speed data transmission are being developed to provide interactive communication ability. From a wired perspective Hybrid Fiber Coax (HFC) is the primary architecture being tested. These systems can utilize a variety of digital modulation schemes, including Quadrature Amplitude Modulation (QAM), Vestigial Sideband (VSB) modulation and Quadrature Phase Shift Keying (QPSK) modulation to achieve efficient spectral communications. Systems trials to-date indicate an excessive amount of time and money are required to deploy these systems. Thus, two way systems being developed will require additional infrastructure to be built and additional customer residence (or premises) equipment to be added. As part of the return path, systems now have to deal with noise ingress problems upstream. Noise ingress requires the addition of special filters placed at the customer premises. Along with access to the customer premises, deployment of these systems cause disruptions in the residential and business community. This system infrastructure must be built out and bypass a customer premises prior to offering any connection for new high data rate one or two way services utilizing this new infrastructure.

An alternative wired system proposes utilizing copper infrastructure and high speed modems to transmit digital two way data. These systems can operate with several modulation schemes including Carrierless Amplitude/Phase (CAP), Discrete Multitone (DMT), DWMT and Subscriber Loop Carrier (SLC). Asymmetrical Digital Subscriber Loop (ADSL), Very-High-Data-Rate Digital Subscriber Line (VDSL) and High-Data-Rate Digital Subscriber Line (HDSL) modems currently under development will offer different data rates to carry communication signals to and from the customer premises. For copper wire based systems limited bandwidth, signal attenuation resulting from the wire gauge and transmission distance all decrease such possible system data rates. Integration into the copper twisted pair network can be active or passive. To maintain the high data rates capabilities of these systems amplifiers will be required to maintain the signal strength and condition between communication points.

Dynamic rate repartitioning (DRR) and seamless rate adaptation (SRA) are capabilities included in ADSL2 and VDSL2 to repartition the rate between latency paths (or bearer channels) and to change the overall data rate over all latency paths (and bearer channels) respectively. A common application for DRR would be to allocate as much bandwidth as possible to a low latency internet channel depending on the number of video channels in use: as users switch off video channels, more internet bandwidth becomes available for example. With DRR, it is highly desirable that existing video streams not be noticeably interrupted when the DRR takes place.

SRA could be used to adjust the data rate to changes in the noise environment. Also, SRA could be envisioned as a way to increase a customer's bandwidth temporarily, for an additional fee, to allow the download of a film for example. Here also, it is desirable that the change of rate not interrupt any current video streams.

DRR and SRA are defined in the ADSL2 standard, however there are limitations to the way they are defined. In ADSL2, only the number of bits per DMT frame, Lp is allowed to change on an interleaved path. This means that a DRR or SRA will also change the overall delay and immunity to impulse noise protection, and it will not be seamless in the sense that there is an instantaneous jump in delay. However, the method in ADSL2 is “error free” meaning that no errors are introduced.

An interleaver/deinterleaver is a pair of building blocks normally used in a digital control and communication system to increase the stability of the system. In general, interleaving spreads the consecutive burst errors introduced into the system to many non-consecutive places so that errors may be easily detected or corrected by, for example, a forward error control (FEC) coding block. The interleaver and deinterleaver may be used together with Reed Solomon FEC (Forward Error Correction) code to combat the impulse noise on a twisted pair telephone line.

In a DSL modem, the interleaver performs an interleaving function on the data frames output from an FEC module. Data may be convolutionally interleaved in accordance with ADSL or VDSL standards to a specified interleave depth. The interleaving process delays each byte of an FEC output data frame by a different amount of time, resulting in the constellation encoder input data frames containing bytes from a number of different FEC output data frames. In general, an interleaver alters the sequence of data bytes of several codewords to more uniformly distribute the effect of signal degradation or noise on the transmission line over different codewords. In an interleaver, data bytes in the data stream are entered into memory cells. After a specified time period, the bytes are read out of the memory cells in an order different from the order in which they entered into the memory cells. The interleaving depth is a parameter that is equal to the number of data bytes in the outgoing interleaved data stream between two data bytes of one and the same codeword or fraction of a codeword. The interleaving depth is a quantitative indicator of the enhancement of immunity of the transmission for burst noise.

Interleaver delay and impulse noise protection can be made the same before and after a rate change by changing the interleaver depth in proportion to the rate change. The delay through the interleaver and deinterleaver pair is, for a 4 kHz DMT frame rate,
interleaver delay=8·(Iₚ−1)(Dₚ−1)/(4·Lₚ) ms (1)
where Iₚ is the interleaver length (typically the codeword size or a factor of the codeword size) and Dₚ is the interleaver depth. The impulse noise protection is
impulse noise protection=8·Dₚ·t/Lₚ DMT frames (2)
where t is the number of bytes corrected by a single Reed-Solomon codeword. If the codeword size is kept constant, then the delay is kept constant as long as
(Dₚ−1)/Lₚ
is constant. And the impulse noise protection is constant as long as
Dₚ/Lₚ
is constant. For large Dₚ, keeping the delay constant and keeping the impulse noise protection constant are nearly the same task.

A truly seamless change in data rate and interleaver depth would be one that holds Dₚ/Lₚ approximately constant, causes no errors, and no variation in the delay as Lₚ and Dₚ are changed. In practice, this can only be approached. The first issue is that DMT frames and RS codewords are not aligned. Therefore, it is not possible to change Lₚ and Dₚ at exactly the same time. The other issue involves the change of interleaver depth. If the interleaver depth is decreased from D_{p,1} to D_{p,2} so that interleaver delay, in bytes, changes from
Δ₁=(N_{FEC,p}−1)(D_{p,1}−1) bytes to
Δ₂=(N_{FEC,p}−1)(D_{p,2}−1)
bytes where Δ₁>Δ₂, then this means that Δ₁−Δ₂ bytes must be received while no bytes are transmitted. Similarly, if the interleaver depth is increased so that Δ₁<Δ₂, then Δ₂−Δ₁ must be transmitted while no bytes are received. This is unavoidable. But if the line rate change happens at the same time, then, on average, there is no delay variation.

FIG. 1 shows an example of decreasing the interleaver depth. During the transition, there is a break in transmission of 2000 bytes while 2000 bytes continue to be received. Of the 10000 bytes transmitted before the line rate changes from 5 Mbit/s to 4 Mbit/s, 8000 are data bytes and 2000 are transient dummy bytes. The line rate continued at 5 Mbit/s and so, on average, the data rate is 4 Mbit/s. From this point of view, the change is seamless even though instantaneously, there is a transient.

Problems associated with an increase or decrease in the interleaver depth include an instant change in delay that could be registered as momentary disruption, the period of the overhead channel in ADSL2 could fall out of the 15-20 ms range and violate the requirements of the recommendation, the interleaver delay could exceed bounds required by the operator as the data rate is reduced, for bonding the data rate must be changed on all bonded modems in exactly the same ratio to maintain the same buffering requirements and approximately and the same differential delay, impulse noise protection will change inversely proportional to the data rate change causing a possible change in the perceived picture quality and TCP/IP throughput performance will change.

True seamless rate change would mean no interruption in data and no change in the delay or perceived quality of the data stream. As the data rate changes, the way to achieve true seamless behavior when the interleaver is enabled is to change the interleaver depth in proportion to the data rate so that the overall delay remains constant. Because the codeword size does not change, the coding gain remains constant as does the immunity to impulse noise.

A problem is, when the interleaver depth changes, it is difficult to structure things in a way that causes no interruption in data and no errors. Different vendors use different algorithms and memory structures to implement interleavers. All implementations, if done properly, result in the same output stream. But if the interleaver depth changes in the middle of the stream, it is very unlikely that two interleaver implementations will produce the same output during a transition period equal to the total end-to-end delay of the interleaver and deinterleaver. Even for a single implementation, the sequence of the output stream after a change in the interleaver depth can change depending on when the transition is made.

In the ADSL2 SRA and DRR schemes, the interleaver size remains constant meaning that the overall delay, impulse noise protection, overhead rate, and overhead period all change in proportion to the change in data rate. Thus, in a DSL system carrying voice, video, and or internet traffic, there is a desire among operators to be able to change the data rate or change the bandwidth allocation between high and low latency paths with minimal or no interruption in service. One solution (currently used in ADSL2) changes only the number of bits carried in each DMT frame but does not change the interleaver depth.

### SUMMARY OF THE INVENTION

In the present invention, a DSL telecommunications system includes a telecommunications line, a first DSL modem coupled to the line operable to communicate data over either a first or second frequency spectrum, and a second DSL modem coupled to the telecommunications line. The preferred embodiment includes a DSL modem capable of performing a method for changing the data rate over an interleaved latency path that overcomes shortfalls of the ADSL2 seamless rate adaptation (SRA) and dynamic rate repartitioning (DRR).

Recent interest in providing triple play services over VDSL2 have prompted a closer look at the capability to change, dynamically, the data rate on a given latency path. It is desirable to change the rate “seamlessly” even when the interleaver is enabled. The present invention includes a method to change the interleaver depth on-the-fly in a way that is as seamless as possible. The present invention creates a transient that is equal to the change in delay. There is no average delay variation. The present invention is adapted for the general convolutional interleaver (GCI) and requires no additional memory on top of the currently available interleaver memory.

### BRIEF DESCRIPTION OF THE DRAWINGS

For a better understanding of the nature of the present invention, its features and advantages, the subsequent detailed description is presented in connection with accompanying drawings in which:

FIG. 1 illustrates dynamic rate and interleaver depth change;

FIG. 2 illustrates a system depicting by way of example the context in which the present inventive embodiments may be implemented;

FIG. 3 illustrates a DSL modem depicting by way of example the context in which the present inventive embodiments may be implemented;

FIGS. 4A-4B illustrate processes of a general convolutional interleaver and deinterleaver;

FIG. 5 illustrates a method of the preferred embodiment;

FIGS. 6A-6C illustrate decreasing the interleaver depth;

FIG. 7 illustrates an alternative method of the preferred embodiment;

FIGS. 8A-8C illustrate increasing the interleaver depth;

FIG. 9 illustrates a method of an alternative embodiment for decreasing the interleaver depth;

FIGS. 10A-10D illustrate decreasing the interleaver depth according to an alternative embodiment;

FIG. 11 illustrates a method of an alternative embodiment for increasing the interleaver depth;

FIGS. 12A-12D illustrate increasing the interleaver depth according to an alternative embodiment.

### DETAILED DESCRIPTION OF THE INVENTION

The preferred exemplary embodiment of the present invention includes a device and method for changing the data rate in seamless rate adaptation (SRA) and dynamic rate repartitioning (DRR) schemes for data transmission over a Digital Subscriber Line (DSL) such as an Asynchronous Digital Subscriber Line 2 (ADSL2) or Very High Speed Digital Subscriber Line 2 (VDSL2).

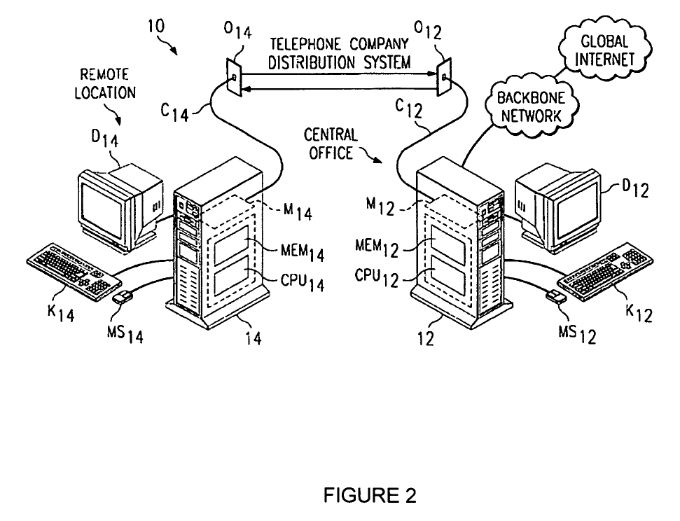

FIG. 2 illustrates a system 10 depicting by way of example the context in which the present inventive embodiments may be implemented. By way of example, system 10 includes aspects which relate to two different geographic locations, one being a telephone company central office and the other being a location remote from that office and, hence, referred to in this document as a remote location. For purposes of appreciating a common example, the remote location may be a home or office of a user in that location, while the central office may be any of those types of offices included in a telephone company system. Stated simply, therefore, these two locations may be fairly close together, or vast distances apart, yet they both may benefit from the present embodiments. These benefits as well as the details of the inventive embodiments are presented below.

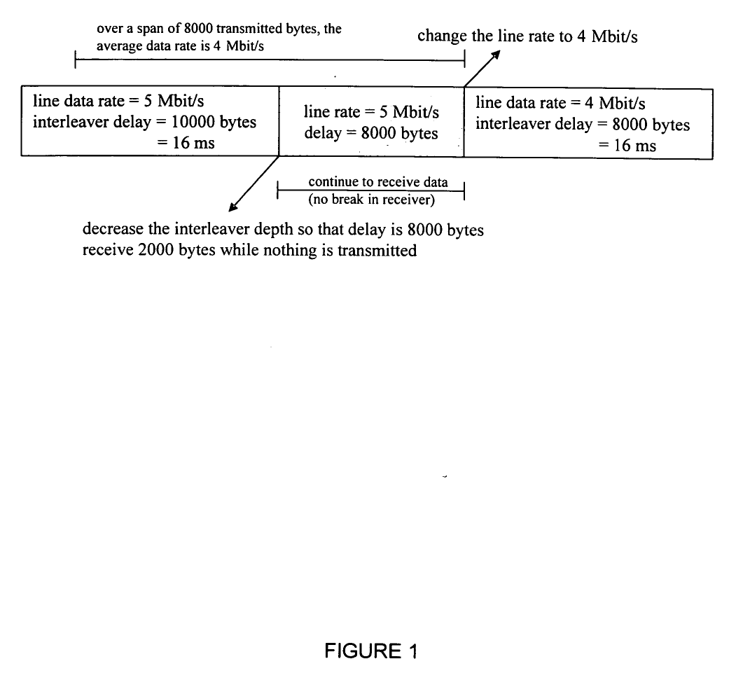

At a minimum for illustrating the preferred embodiments, each of the central office and remote location houses a computer 12 and 14, respectively. Computers 12 and 14 may be of any type of known computer configurations and, indeed, the type of computing device at the remote location may well differ from the type or configuration of that used at the central office (e.g., a rack system). Typically, therefore, a user of either computer may provide input to a corresponding computer, such as by way of a keyboard K and a mouse MS or other input or pointing device as known in the art. To simplify the present illustration, note for purposes of FIG. 1 that each of the reference identifiers for these items (i.e., K and MS) as well as for other items discussed below further includes a subscript reciting the reference number of the corresponding computer. For example, computer 12 includes keyboard K.sub.12 and mouse MS.sub.12. Continuing with this convention and looking to other attributes of computers 12 and 14, each computer preferably includes some device for presenting output to a user, such as a display D. Internally to each computer may be various circuits including those mounted on circuit boards and/or cards, including a motherboard (shown in phantom) which includes a memory MEM, a central processing unit CPU or more than one such CPU as may likely be the case for computer 12, and likely other circuitry (not shown).

Of particular note to the present embodiments, also included preferably internal to each computer and, thus, shown in phantom, is a modem M so that each of computers 12 and 14 may communicate with one another over a standard telephone company distribution system. In the case of computer 12, note that it is likely to actually include and support multiple modems, although only one is shown to simplify the illustration as well as the following discussion. Looking to the distribution system along which the modems communicate, it includes twisted conductor pairs accessible for a connection between computers 12 and 14. In this regard, modem M.sub.14 of computer 14 provides an output which is provided to a standard telephone or other applicable connector and, thus, is connected to a telephone wall outlet O.sub.14 via a standard telephone communication cable C.sub.14. This connection permits communication from modem M.sub.14 over the telephone company distribution system and, therefore, with modem M.sub.12 of computer 12. Note that while comparable connections using cable C.sub.12 and outlet O.sub.12 are shown at the telephone company, more typical industrial type connections may actually exist at that end of the connection. Lastly, given the communications of modems M.sub.12 and M.sub.14 with one another, note that in the preferred embodiment such communications are by way of a DSL category referred to as Medium-bit-rate Digital Subscriber Line (MDSL) technology, which currently contemplates downstream communications up to 2.8 Mbps and upstream communications up to 768 Kbps. One skilled in the art, however, will appreciate that many of the present teachings also provide aspects and benefits which may be implemented in other DSL categories.

Given system 10 of FIG. 2, it is intended that its components are used within the present inventive scope to accomplish DSL communications between modems M.sub.12 and M.sub.14. In this regard, note that computer 12 is connected via an appropriate interface I/F to a backbone network. This network may be of various types, with Ethernet being a popular contemporary example. As a result, computer 12 may communicate with any other device or resource which also is coupled to communicate with the backbone network. Indeed, as one example, FIG. 2 illustrates that the Internet is also coupled to the backbone network through some kind of networking architecture. Consequently, computer 12 may communicate, via the backbone network, with the Internet Additionally, due to the modem-to-modem communication path between computers 12 and 14, computer 14 also may use DSL communications for accessing other media available to computer 12 at the telephone company central office. In the system of FIG. 2, while both ADSL modem M12 may be connected over network lines to an Internet Protocol (IP) phone or an IP video device (not shown) and handle transmissions for these devices.

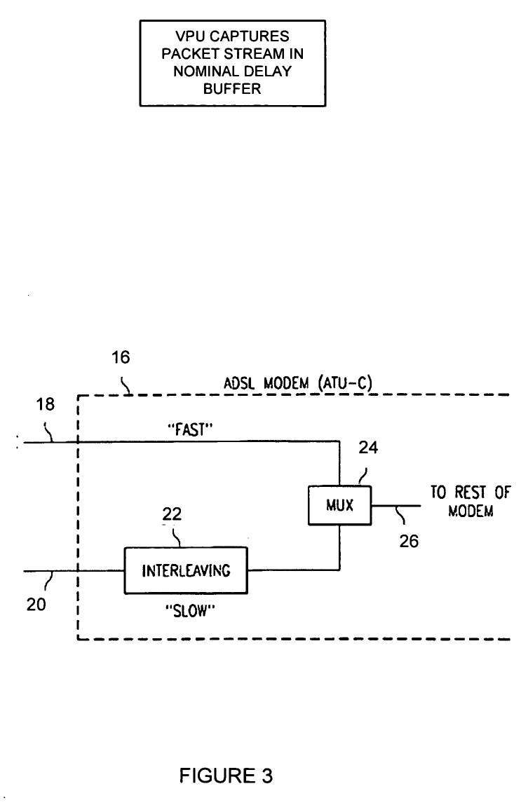

FIG. 3 is a block diagram of a central office ADSL transceiver unit (ATU-C) 16 such as ADSL modem M14. The modem unit 16 includes two latency paths, one labeled “fast” 18 and the other labeled “slow” 22. The “slow” latency path also includes an interleaving device 22. The fast and slow interfaces 18 and 22, respectively, enter the modem unit 16 on separate paths and are multiplexed together by multiplexer 24 before entering the rest of the modem for further processing through path 26.

The general convolutional interleaver (GCI) can be implemented with a series of First-In First-Out (FIFO) buffers just like a triangular interleaver used in VDSL1. The differences are that the number of delay elements in each FIFO does not form a regular triangular pattern and the order in which data is read from the FIFOs is not generally in linear order. The parameters of the GCI are I and D where I=N_{FEC}/q is the length of the interleaver, N_{FEC} is the Reed-Solomon codeword size, q is an integer that evenly divides N_{FEC} and D is the interleaver depth. In the VDSL1 triangular interleaver, the restriction D=M*I+1 is imposed where M is an integer. With the GCI, this is relaxed so that
D=M*I+x (3)
where x is any integer provided that D and I are co-prime meaning that they have no common factors greater than one.

Effectively, the GCI can be broken into two interleavers, a multiplexed interleaver and a block interleaver. The multiplexed interleaver can be thought of as the series of FIFOs and the block interleaver can be thought of as the re-ordering of the data coming out of the FIFOs.

In U.S. Pat. No. 3,652,998 to Forney, the interleaver is characterized by three parameters, I, D, and m.² Following Forney, we call this an (I, D, m) interleaver. The GCI delays each input byte by the amount, f(i), where 0≦i<I represents the index of the input byte. The delays out of the interleaver can be written as

$$\begin{matrix}f ( i ) = 0 , ( m mod l ) * ( D - 1 ) , ( 2 m mod l ) * ( D - 1 ) , … ( m * ( l - 1 ) mod l ) * ( D - 1 ) & ( 4 ) \\ = ( m * i mod l ) * ( D - 1 ) ; 0 \leq i < l & ( 5 )\end{matrix}$$

The GCI is a periodic interleaver meaning that this pattern of delays is repeated. For all DSL recommendations, m=1. The deinterleaver is an (I, D, n) interleaver with
n=(−D⁻¹)mod I (6)

The deinterleaver delays are re-ordered (rotated) with respect to the interleaver so that the first delay is equal to (I−1)*(D−1) rather than 0. The overall delay due to interleaving and deinterleaving is (I−1)*(D−1) bytes. Forney uses P instead of I as the period of the interleaver and refers to the interleaver delay, D, rather than the interleaver depth, D=D+1.

The number of delay elements in each FIFO is represented by q(i)=floor(i*D/I). The order that the FIFOs are read is determined by a second vector, r(i)=i*D mod I.

Another way of writing this is to write the relationship between the input and output of the interleaver. If the interleaver output is y(n) and the input x(n) at time n, we can say that y(n+f(i))=x(n) where i=n mod I. This can be equivalently rewritten as y(n)=x(n−f(r⁻¹(i))) where r⁻¹(r(j))=j.

For the triangular interleaver, q(i)=M*i and r(i)=r⁻¹(i)=i. For the GCI, equation (3) can be substituted into equation (5) to obtain

$$\begin{matrix}f ( i ) = i * ( M * l + x - 1 ) \\ = i * M * l + x * i - i\end{matrix} \qquad ( 8 )$$

from which we find that r(i)=(x mod I)*i and therefore, as long as x and I are constant, r(i) will be constant.

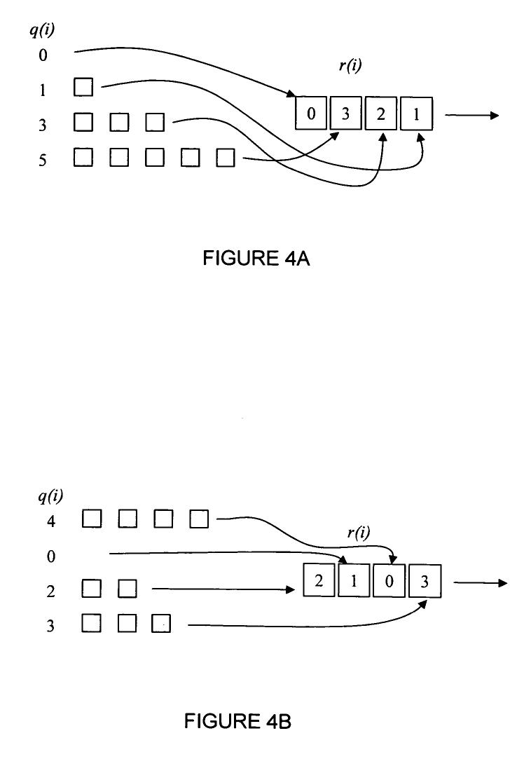

As an example, assume I=4, M=1, and x=3 such that D=1*4+3=7. For this case, the values of q(i) and r(i) for the interleaver are shown in Table 1, below, and in FIG. 4A.

TABLE 1
Table showing multiplexed and block interleaver values for M = 1,
x = 3, and l = 4. r(i) is selected so that r(i) < l.

i

| | 0 | 1 | 2 | 3 |
|---|---|---|---|---|
| f(i) | 0 | 6 | 12 | 18 |
| q(i) | 0 | 1 | 3 | 5 |
| r(i) | 0 | 3 | 2 | 1 |

FIG. 4A is an illustration of an interleaver when I=4 and x=3. Each empty square represents M delay elements and each row is a FIFO. Data is read out from the right, the FIFO is shifted to the right, and new data is written in the left in natural order. When the delay is zero, the new data is immediately sent to the block interleaver.

For the example that assumes I=4, M=1, and x=3 such that D=1*4+3=7, the values of q(i) and r(i) for the deinterleaver are shown in Table 2, below, and in FIG. 4B.

TABLE 2
Parameters defining the deinterleaver for l = 4,
x = 3, n = 1, and M = 1.

i

| | 0 | 1 | 2 | 3 |
|---|---|---|---|---|
| f(i) | 18 | 0 | 6 | 12 |
| q(i) | 4 | 0 | 2 | 3 |
| r(i) | 2 | 1 | 0 | 3 |

FIG. 4B illustrates a deinterleaver when I=4 and x=3. Data is written in the left in natural order (from top to bottom) and read out in r(i) order. Each empty box represents M delay elements.

In the preferred embodiment, changes are allowed only to M and not to x. This way, the ordering of the FIFOs is unchanged and the depth change algorithm is simplified. This means that the interleaver depth can change in steps of I.

For exemplary purposes of demonstrating the preferred embodiment, the values of I=4, x=3, and M varying between one and two are used. The interleaver and deinterleaver parameters for M=2 are given in Table 3 and Table 4, respectively. Again, q(i) indicates the number of delay elements in each FIFO row and r(i) indicates the order that the FIFOs are read. As expected, r(i) for M=2 is the same as r(i) for M=1 as shown in Table 1 and Table 2.

i

| | 0 | 1 | 2 | 3 |
|---|---|---|---|---|
| f(i) | 0 | 10 | 20 | 30 |
| q(i) | 0 | 2 | 5 | 8 |
| r(i) | 0 | 3 | 2 | 1 |

Table 3 showing multiplexed and block interleaver values for M=2, I=4, x=3. r(i) is selected so that r(i)<I.

i

| | 0 | 1 | 2 | 3 |
|---|---|---|---|---|
| f(i) | 30 | 0 | 10 | 20 |
| q(i) | 7 | 0 | 3 | 5 |
| r(i) | 2 | 1 | 0 | 3 |

Table 4 showing parameters defining the deinterleaver for l=4, x=3 and M=2.

For the present invention, the complete interleaver cycle is referenced. A complete cycle begins with the top FIFO and ends with the bottom FIFO. The complete cycle runs through all I FIFOs. All depth change operations happen on cycle boundaries, that is, depth change operations occur at multiples of I bytes.

When decreasing the interleaver depth, the preferred embodiments continue to receive data at the α/β-interface but suspend transmitting data across the α/β-interface for a duration equal to Δ_{old}−Δ_{new} bytes where Δ is the interleaver delay in bytes. The α/β-interface is the interface between the TPS-TC and the PMS-TC.

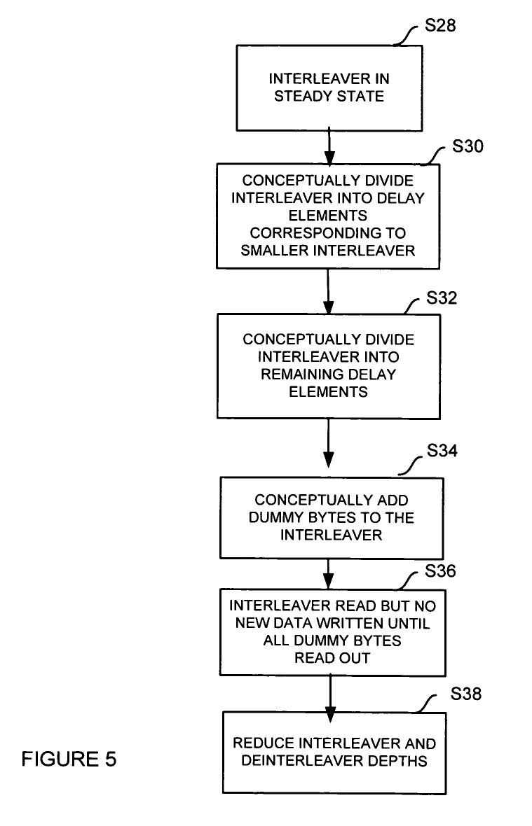

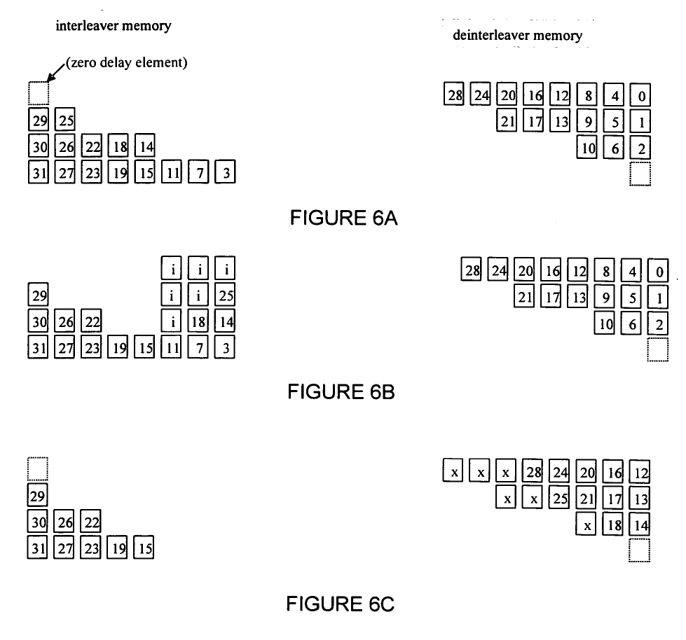

The following example changes the interleaver settings from I=4, M=2, x=3, D=11 to a smaller depth with I=4, M=1, x=3, D=7. Referring contemporaneously to the method in FIG. 5 and the interleaver memory illustration in FIGS. 6A to 6C, blocks marked with ‘i’ are not actually stored. Blocks marked with an ‘x’ are stored and then discarded. Values are written into the interleaver in consecutive order starting at 0. Initially the interleaver is in steady state S28 as shown in FIG. 6A with M=2, x=3, I=4, D=11. In FIGS. 6A to 6C, the reordering is ignored for illustration purposes. Because the reordering is ignored, more delay elements are shown in the deinterleaver than actually exist in the deinterleaver. The reason more are shown is that the block interleaver adds delay. In this example, Δ_{old}=(I−1)(D−1)=30 and Δ_{new}=18 for a change of 12 bytes. As we will see, transmission is suspended for 12 bytes.

The first step in decreasing the interleaver depth is to think of the interleaver as having two sections. The leftmost section has delay elements corresponding to the new smaller interleaver S30 with, in this case, M=1. The rightmost section has the remaining delay elements S32. In between these two sections we conceptually add dummy entries S34 into the interleaver (marked as blocks with ‘i’) as shown in FIG. 6B. The number of dummy entries in each row is such that once all of the dummy entries are read out, the deinterleaver memory will be filled with dummies in all locations that are not required for the smaller interleaver depth. Data is written and read normally from the deinterleaver. The dummy entries are not actually written or stored into the interleaver, but they are transmitted to the receiver and stored there. When entering this step, there is no actual change to the interleaver or deinterleaver memory. Once the interleaver is divided and the dummy entries are conceptually added, the interleaver is read but no new data is written S36. This continues for the number of complete cycles required to read out all dummy bytes.

After all dummy bytes are read out of the interleaver, both the interleaver and deinterleaver depth can be reduced S38 without losing any data. FIG. 6C shows that once all five columns (through element 19) are read through, the interleaver and deinterleaver memory are as shown. At this point, the interleaver depth is reduced to M=1, x=3, I=4, and D=7 and the interleaver continues into steady state at the new depth. In this procedure, the dummy bytes are not appended to the end of the interleaver. The reason for this is to provide a simpler deinterleaver implementation while not further complicating an interleaver implementation.

In this process for decreasing the depth, transmission across the α/β-interface transmitter was suspended for twelve bytes, six dummy bytes were transmitted across the U-interface (over the channel), and no dummy bytes were received or discarded across the α/β-interface receiver. In general, transmission is suspended for Δ_{old}−Δ_{new} bytes and (Δ_{old}−Δ_{new})/2 dummy bytes are transmitted over the U-interface.

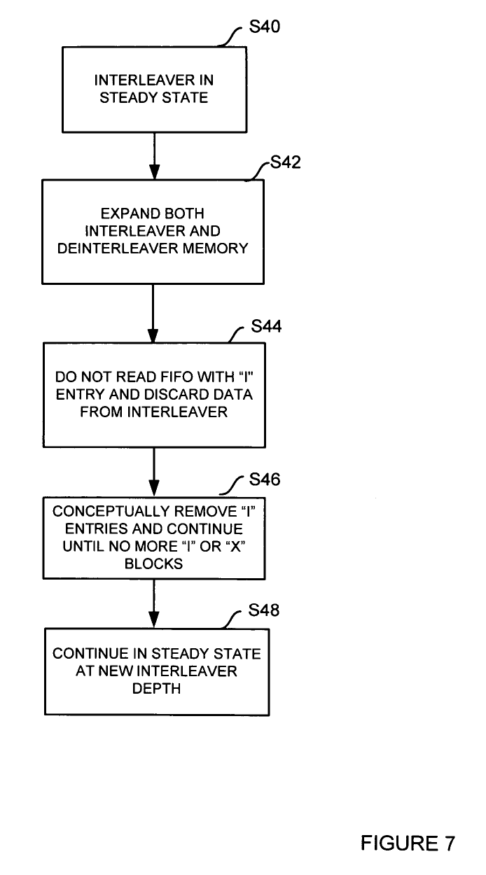

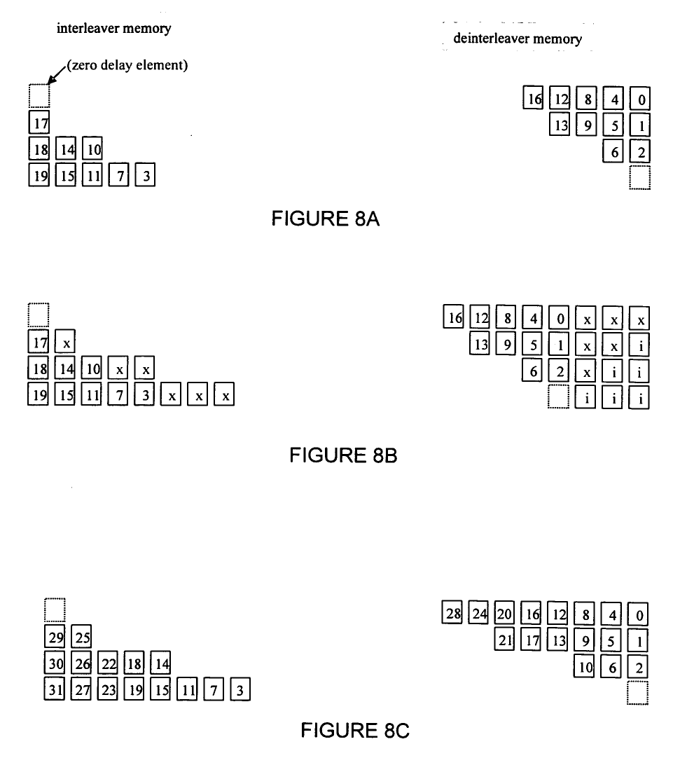

FIG. 7 shows the steps for a preferred method of increasing the interleaver depth. Also, FIGS. 8A-8C continue with the example used to demonstrate decreasing the interleaver depth but instead illustrate an increase in the depth from seven to eleven. Here, Δ_{old}=18 and Δ_{new}=30. As the depth of the interleaver is increased, it never stops transmitting data across the α-interface, but it discards Δ_{old}−Δ_{new}=12 bytes at the β-interface to allow for the increased delay.

Following FIG. 8A, the preferred method for increasing the depth begins in steady state at the smaller interleaver depth S40 with M=1, x=3, I=4, D=7. Step S42 (shown in FIG. 8B) is to expand both the interleaver and deinterleaver memory. Both the interleaver and deinterleaver memory are expanded to new depth by adding memory to the right side of the FIFOs shown with “x”. When the memory is expanded, the added entries contain what is effectively dummy bytes. At this point, we continue to use the interleaver exactly as before except at the new interleaver depth. As we see, this means we transmit 6 dummy bytes across the U-interface.

On the deinterleaver side, there is a transition period where the operation is not normal. As we cycle through the FIFOs, where there is an ‘x’ to read, we read the FIFO, throw out the data, shift the FIFO as normal and write the new entry. Where there is an ‘i’, the FIFO is not read the data received from the interleaver is discarded S44. Then we conceptually remove the entry with the ‘i’ S46. This continues for complete cycles until there are no more ‘i’ or ‘x’ blocks. Then as shown in FIG. 8C, the process continues in steady state at the larger interleaver depth S48 Once all “i” blocks are read and removed from the deinterleaver, the steady state continues with M=2, x=3, I=4, and D=11.

The method of the preferred embodiment drains or fills the amount of memory related only to the change in interleaver depth, not the entire (de)interleaver memory. It is also error free. In this way, it can be argued that the method presented here is, on average, truly seamless. It requires no additional memory.

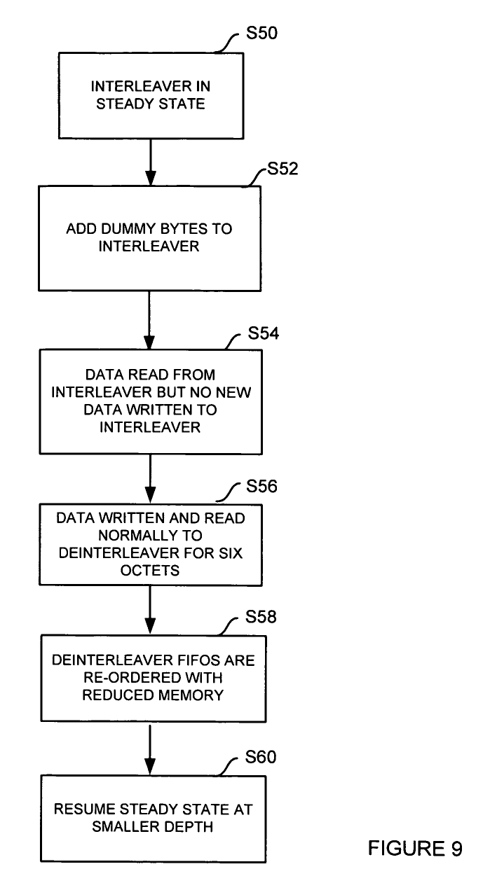

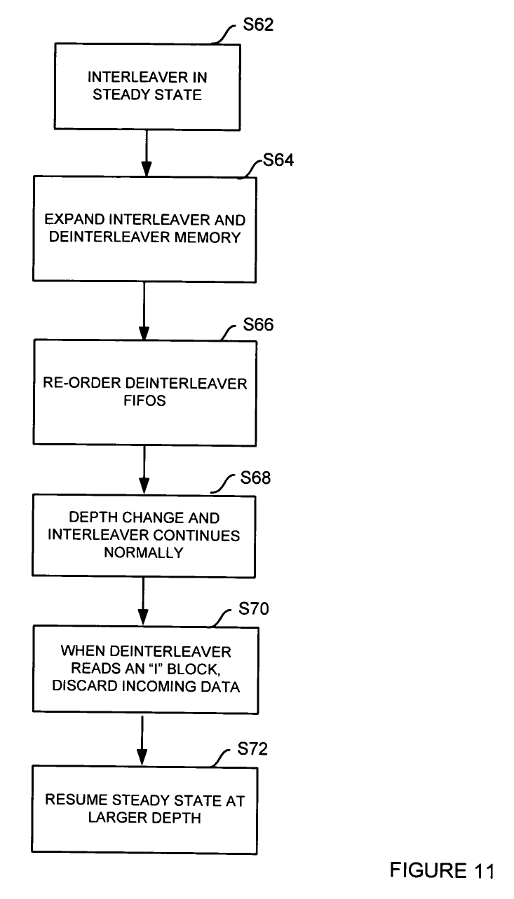

Although the preferred embodiment presents a method for how to change the interleaver depth of a generalized convolutional interleaver on-the-fly, this method has a restriction that the change of the interleaver depth is in multiples of I bytes. An alternative embodiment includes an interleaver depth change in any granularity. FIG. 9 shows steps for an alternative method of decreasing interleaver depth in a general case with no restriction on granularity of depth change. FIG. 11 also shows steps for increasing interleaver depth in a general case with no restriction on granularity of depth change. The alternative embodiments include a DSL modem 16 over a network 10 performing the alternative methods.

The procedure to change the interleaver depth from any depth to any other depth (any granularity) can be explained in reference to the preferred procedure for changing the interleaver depth in steps of I. The differences are that in both cases, transmission (for a decrease in depth) or reception (for an increase in depth) is suspended for a time equal to at least the change in end-to-end delay. When the depth is changed in steps of I, this change in delay is a multiple of I. When the depth is not changed by a multiple of I, the suspension time is not a multiple of I which could complicate the design. Another difference from the preferred method is that when the depth change is a multiple of I, the FIFO order remains constant. Otherwise, the FIFO ordering changes.

When decreasing the depth, the transmission is suspended for the duration of the delay change while the interleaver continues to receive data. The old delay is equal to (D1−1)*(I−1) octets where D1 is the initial interleaver depth. The new delay is (D2−1)*(I−1) octets. Therefore, transmission is suspended for at least (D1−D2)*(I−1) octets and dummy bytes are added as explained more fully below.

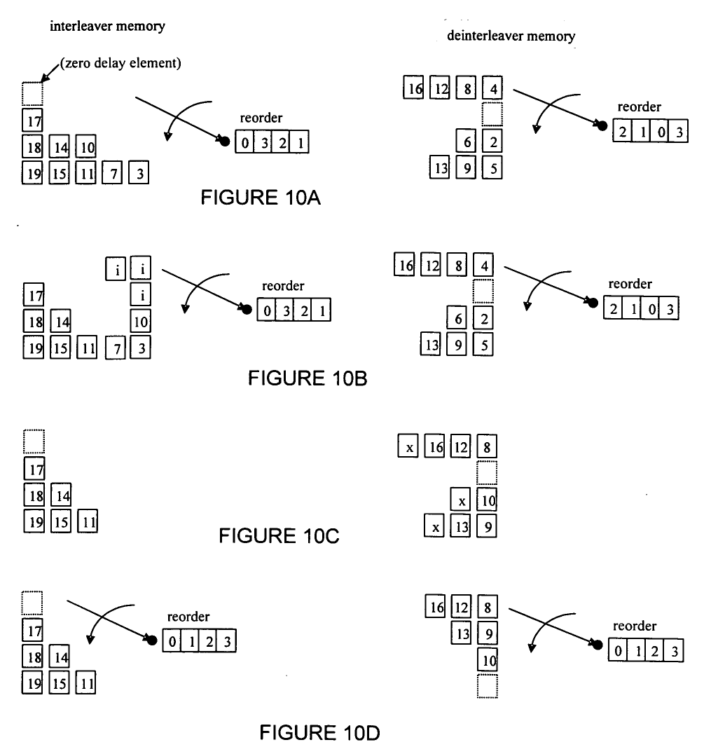

Referring to both FIGS. 9 and 10A-10D, FIG. 10A shows an interleaver in steady state S50 with M=1, x=3, I=4, D=7. In FIG. 10B the depth change process begins by adding dummy bytes S52 as shown to the interleaver with blocks marked ‘i’. Dummy bytes are not actually stored in memory but they are transmitted to the receiver. Data is read from the interleaver normally but no new data is written into the interleaver S54. Data is written and read normally from the deinterleaver S56. Transmission is suspended for six octets. FIG. 10C shows the next step S58 as during the time transmission was suspended (e.g., six octets), the deinterleaver was written and read normally for six octets. Content of memory after the six octets is shown in FIG. 10C. Deinterleaver FIFO is only written if it is read. FIG. 10D shows the next step S58. Deinterleaver FIFOs are re-ordered with reduced memory and in steady state is resumed S60 at the smaller depth with M=1, x=1, I=4, D=5.

The relationship between the interleaver input, x(n), and output, y(n) at the old interleaver depth can be written as y(n)=x(n−f_{old}(r_{old}⁻¹(i))) and at the new depth as y(n)=x(n−f_{new}(r_{new}⁻¹(i))−delay) where “delay” is the time during which interleaver writing is suspended. At some time, n=k, the old larger interleaver depth is switched to the new smaller interleaver depth. With this formulation, some input values will be transmitted twice. According to the preferred embodiment, the first of the repeated output words can be considered dummy bytes and ignored at the receiver. This allows other implementations that may or may not use the FIFO delay line concept.

When increasing the interleaver depth reception of data is suspended while transmission continues. Similarly to the decrease in depth, the duration of the suspension is (D2−D1)*(I−1) octets. This is shown more fully below.

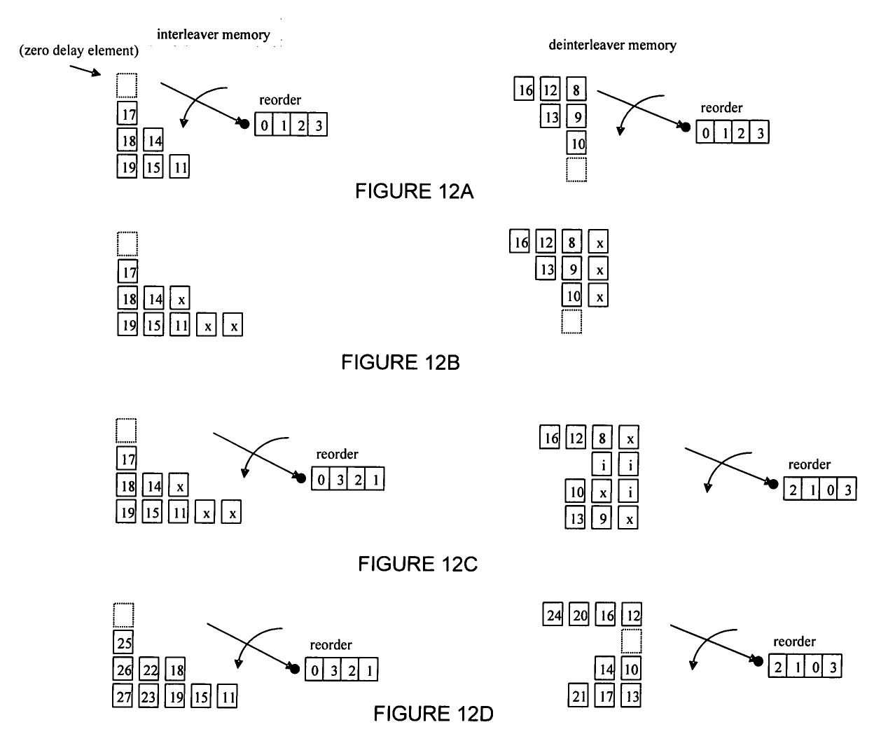

An alternative embodiment for increasing the interleaver depth is shown in FIGS. 11 and 12A-12D. FIG. 12A shows the process where a steady state with M=1, x=1, I=4, D=5 in the interleaver is obtained S62. FIG. 12B shows a step S64 in depth change where the interleaver and the deinterleaver memory is expanded as shown. FIG. 12C shows the next step S66 in depth change to re-order deinterleaver FIFOs. After a depth change, the interleaver continues normally with data read, the FIFOs are shifted, and new data is written on the left S68. On the deinterleaver side, blocks marked with “i” are not actually written into memory—they are conceptual only. When the deinterleaver reads an “i” block, it removes it and ignores (discards) the incoming data from the interleaver S70 and FIFOs are not shifted. Reception of data is suspended for six octets. FIG. 12D shows the step S72 when the deinterleaver FIFOs are re-ordered with increased memory and the interleaver resumes handling data in steady state at the larger depth with M=1, x=3, I=4, D=7.

The relationship between the interleaver input, x(n), and output, y(n) at the old interleaver depth can be written as y(n)=x(n−f_{old}(r_{old}⁻¹(i))) and at the new depth as y(n)=x(n−f_{new}(r_{new}⁻¹(i))). At some time, n=k, the old smaller depth is switched to the new larger depth. There is no delay here because interleaver writes are not suspended when increasing the depth. As in the decrease of interleaver depth, some input values will be output twice according to the input/output equations. According to the preferred embodiment, the second ocurrence of an output is considered a dummy word and can be ignored by the receiver. This is illustrated in FIG. 12B.

The embodiments of the present invention can be applied to any dynamic rate change procedure for ADSL2 or VDSL2 that involves the interleaved path. The present rate change procedure allows the interleaver depth to change so that the interleaver delay before and after the rate change are nearly equal, resulting in consistent impulse noise protection and overhead rate. A change of rate also results in a short break in the data stream, where the length of the break is approximately equal to the end-to-end interleaver delay.

One skilled in the art will appreciate that the present invention can be practiced by other than the described embodiments, which are presented for purposes of illustration and not limitation, and the present invention is limited only by the claims that follow.

What is claimed is:

1. A method for data transmission in a modem, comprising:
changing an interleaver depth on an interleaved data path during a DSL transmission of data.

2. The method of claim 1, wherein the changing comprises decreasing the interleaver depth during the data transmission without interruption, by the decreasing, to data being received and with an interruption of transmitted data.

3. The method of claim 1, further comprising
decreasing a deinterleaver depth during data transmission without interruption, by the decreasing, to data being received and an with interruption of transmitted data

4. The method of claim 2, wherein dummy bytes are sent by a transmitting modem and discarded by a receiving modem.

5. The method in claim 2, wherein an interleaver output at a time n, y(n), and an interleaver input, x(n) are related by y(n)=x(n−f_{old}(r_{old}⁻¹(i))) before the decrease in depth and by y(n)=x(n−f_{new}(r_{new}⁻¹(i))−delay) after the increase in depth, where f( ) and r⁻¹( ) are determined by an interleaver length and depth and delay represents a break in the data transmission.

6. The method of claim 5, wherein the change in interleaver depth occurs at a time, n=k, negotiated between a transmitter a receiver.

7. The method of claim 5, wherein a first occurrence of repeated octets are considered dummy octets.

8. The method of claim 7, wherein an old and a new interleaver depth can be any valid value.

9. The method of claim 8, wherein the delay is equal to (D_{old}−D_{new})*(I−1), wherein D_{new} is the new smaller interleaver depth, and D_{old} is the old larger interleaver depth, and I is the interleaver length.

10. The method of claim 1, wherein the changing comprises increasing the interleaver depth without interruption, by the increasing, in data being transmitted and with an interruption of received data.

11. The method of claim 1, wherein the changing comprises increasing the deinterleaver depth without interruption, by the increasing, in data being transmitted and with an interruption of received data.

12. The Method of claim 10, wherein dummy bytes are sent by a transmitting modem and are discarded by a receiving modem

13. The method of claim 12, wherein an interleaver output at a time n, y(n), and an interleaver input, x(n) are related by y(n)=x(n−f_{old}(r_{old}⁻¹(i))) before an decrease in depth and by y(n)=x(n−f_{new}(r_{new}⁻¹(i) after an increase in depth where f( ) and r⁻¹( ) are determined by the interleaver length, and
wherein the change in interleaver depth occurs at a time, n=k, negotiated between a transmitter a receiver.

14. The method in claim 13 wherein a second occurrence of repeated octets are considered dummy octets

15. The method in claim 14, wherein an old and a new interleaver depth can be any valid value.

16. The method in claim 15, wherein the delay is equal to (D_{new}−D_{old})*(I−1), wherein D_{new} is the new larger interleaver depth, and D_{old} is the old smaller interleaver depth, and I is the interleaver length.

17. A system for data transmission, comprising:
a first modem on a digital subscriber line (DSL line);
a second modem, operatively connected to the first modem on a network used by the DSL line,
wherein a depth is changed in an interleaver in the first modem during a DSL transmission of data.

18. The system of claim 17, wherein the first modem interleaver depth is decreased during the data transmission without interruption, by the decreasing, to the data being received and with an interruption of transmitted data.

19. The system of claim 17, wherein the first modem decreases a deinterleaver depth during the data transmission without interruption, by the decreasing, to data being received and an with interruption of transmitted data.

20. The system of claim 17, wherein the first modem increases the interleaver depth without interruption, by the increasing, in data being transmitted and with an interruption of received data, and
the first modem increases a deinterleaver depth without interruption, by the increasing, in data being received and with an interruption of transmitted.
